(19) United States
(12) Patent Application Publication
(10) Pub. No.: US 2011/0139530 A1
(43) Pub. Date: Jun. 16, 2011

(54) FOLDABLE ELECTRICALLY POWERED VEHICLE

(76) Inventor: Anil ANANTHAKRISHNA, Norcross, GA (US)

(21) Appl. No.: 12/887,447

(22) Filed: Sep. 21, 2010

Related U.S. Application Data
(60) Provisional application No. 61/244,415, filed on Sep. 21, 2009.

(51) Int. Cl. B62M 6/60; B62K 15/00; B62K 19/02

(52) U.S. Cl. 180/206.5; 280/287

(57) ABSTRACT

A foldable electrically powered vehicle is disclosed. In one embodiment, a foldable electrically powered vehicle includes a foldable chassis frame having members connected using interlocking elements such that the foldable chassis frame is folded by unlocking each interlocking element connecting the members. The vehicle also includes a front fork interlocked with the first member of the foldable chassis frame and a swing arm interlocked with the second member of the foldable chassis frame. Moreover, the vehicle includes a rear fork interlocked with the third member of the foldable chassis frame. The foldable chassis member, the front fork, the rear fork and the swing arm are detached by unlocking respective interlocking elements.

### PRIORTIY CLAIM

Benefit is claimed under 35 U.S.C. 119(e) to U.S. Provisional Application Ser. No. 61/244,415, titled “FOLDABLE ELECTRICALLY POWERED VEHICLE WITH PORTABLE POWER PACK” by Anil Ananthakrishna, filed on Sep. 21, 2009, which is herein incorporated in its entirety by reference for all purposes.

### BACKGROUND OF THE INVENTION

1. Field of the Invention

Embodiments of the disclosure generally relate to the field of vehicles, and more particularly to electrically powered vehicle.

2. Summary of the Prior Art

Recently, electrically powered vehicles have become popular especially for personal transport purpose. The electrically powered vehicles produce zero emission as compared to vehicles driven by conventional energy source. The electrically powered vehicles are driven by one or more electric motors coupled to wheels. These electric motors are driven by electric power source such as batteries. In order to drive a electrically powered vehicle, a huge amount of power is required to be supplied by the batteries, resulting in a large battery size for storing the electric power. Consequently, the batteries supplying the electric power add up to the size requirement in the electrically powered vehicle.

Currently, the charge in the battery can drive a vehicle to a few miles. Hence, the use of the electrically powered vehicle is restricted for use within city limits due to limited charge. Also, due to large storage space requirement, these vehicles cannot be transported from one place to another for other purposes such as riding in the terrain region, picnic spots, and the like.

### SUMMARY OF THE INVENTION

This Summary is provided to comply with 37 C.F.R. §1.73, requiring a summary of the invention briefly indicating the nature and substance of the invention. It is submitted with the understanding that it will not be used to interpret or limit the scope or meaning of the claims.

A foldable electrically powered vehicle is disclosed. In one aspect, a foldable electrically powered vehicle includes a foldable chassis frame having members connected using interlocking elements such that the foldable chassis frame is folded by unlocking each interlocking element connecting the members. The vehicle also includes a front fork interlocked with the first member of the foldable chassis frame and a swing arm interlocked with the second member of the foldable chassis frame. Moreover, the vehicle includes a rear fork interlocked with the third member of the foldable chassis frame. The foldable chassis member, the front fork, the rear fork and the swing arm are detached by unlocking respective interlocking elements.

In another aspect, a first member, a second member interlocked with the first member using a first interlocking element, and a third member interlocked with the second member using a second interlocking element, where the chassis frame is folded to form member stack by unlocking the first and second interlocking elements.

Other features of the embodiments will be apparent from the accompanying drawings and from the detailed description that follows.

### BRIEF DESCRIPTION OF THE VIEW OF THE DRAWING

FIG. 1 illustrates a perspective view of a foldable electrically powered vehicle, according to one embodiment.

FIGS. 2A and 2B illustrate schematic representations of various detached structural assemblies of the foldable electrically powered vehicle of FIG. 1, according to one embodiment.

FIG. 3 illustrates a schematic representation of an inflatable honeycomb beehive type structure used in the body of the foldable electrically powered vehicle of FIG. 1, according to one embodiment.

FIG. 4 illustrates a schematic representation of a portable power pack with belt/nap sack for driving the foldable electrically powered vehicle of FIG. 1, according to one embodiment.

FIG. 5 illustrates a schematic representation of the foldable electrically powered vehicle of FIG. 1 having batteries embedded in rim of the wheels and layers of solar cells on the body of the vehicle, according to one embodiment.

The drawings described herein are for illustration purposes only and are not intended to limit the scope of the present disclosure in any way.

### DETAILED DESCRIPTION OF THE INVENTION

A foldable electrically powered vehicle is disclosed. The following description is merely exemplary in nature and is not intended to limit the present disclosure, applications, or uses. It should be understood that throughout the drawings, corresponding reference numerals indicate like or corresponding parts and features.

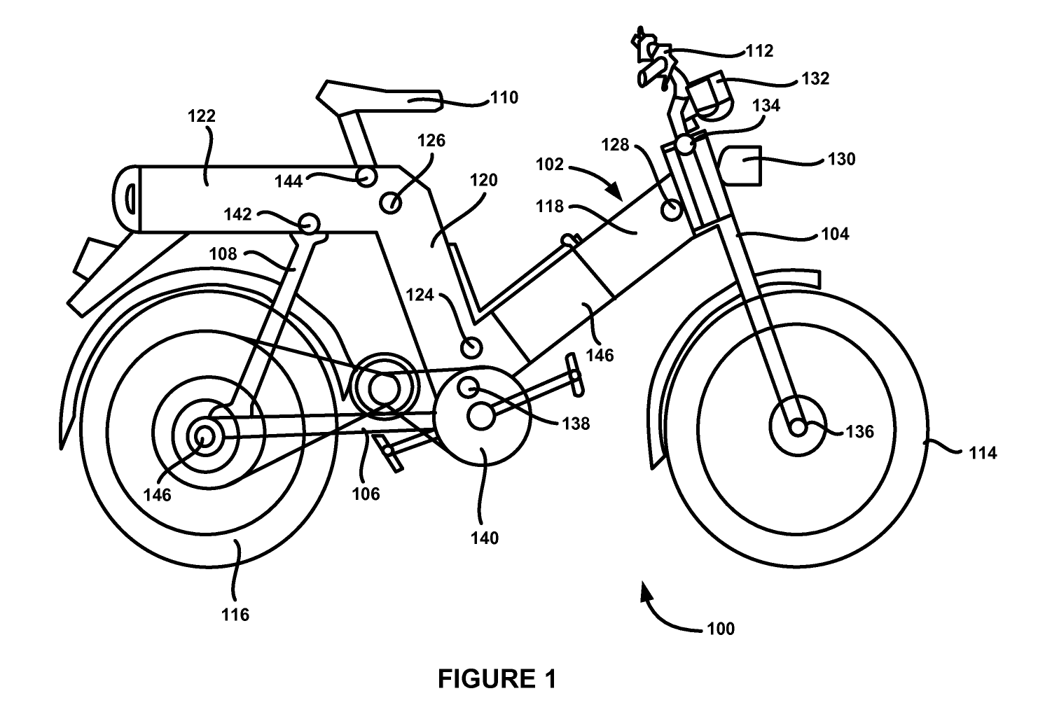

FIG. 1 illustrates a perspective view of a foldable electrically powered vehicle 100, according to one embodiment. In FIG. 1, the foldable electrically powered vehicle 100 includes a foldable chassis frame 102, a front fork 104, a swing arm 106, a rear fork 108, an adjustable seat member 110, a handle with brake speed control throttle 112, a front wheel 114, and a rear wheel with electric motor 116.

The foldable chassis frame 102 includes three members, viz. a first member 118, a second member 120, and a third member 122. Each of these members is interlocked with another member using an interlocking element. For example, the second member 120 is interlocked with the first member 118 using an interlocking element 124. Similarly, the third member 122 is interlocked with the second member 120 using an interlocking element 126. In one embodiment of the present invention, the foldable chassis frame 102 can be folded by unlocking the interlocking elements 124 and 126.

Further, the front fork 104 is interlocked with the first member using an interlocking element 128. The front fork 104 includes a head lamp 130 and an instrument console 132. The handle with brake speed control throttle 112 is mounted interlocked with the front fork 104 using an interlocking member 134. Also, the front wheel 114 is mounted interlocked with the front fork 104 using an interlocking member 136.

The swing arm 106 is interlocked with the second member 120 using an interlocking member 138. The swing arm 106 includes a pedal crank 140 connected to it for starting the electrically powered vehicle 100. The rear fork 108 is interlocked with the third member 122 using an interlocking member 142. Also, the adjustable seat member 110 is interlocked with the third member 122 using an interlocking member 144. Further, the rear wheel along with electric motor and drive mechanism 116 is mounted interlocked with the intersection joint of the swing arm 106 and the rear fork 108 using an interlocking member 146.

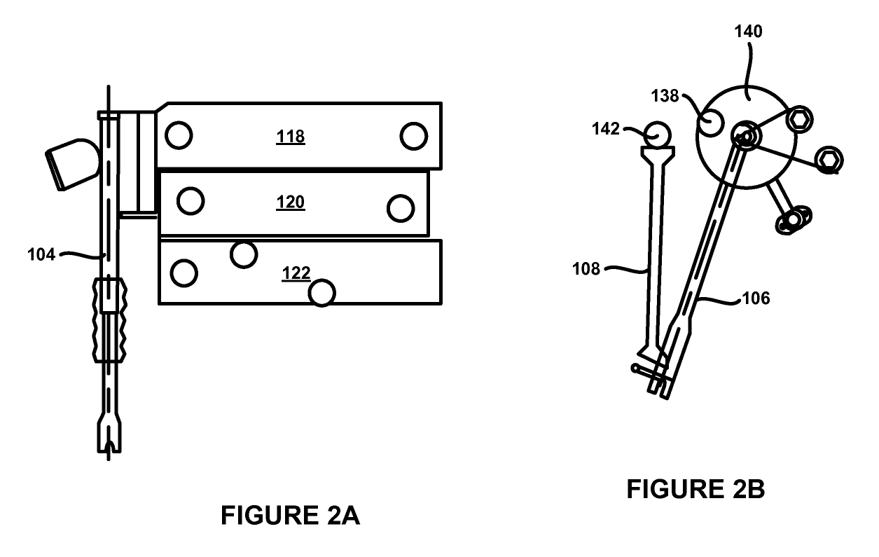

According to the embodiments of the present invention, in the event of carrying of electrically powered vehicle to distinct locations or for any other purpose, the foldable chassis frame 102 with the front fork 104, the swing arm 106 and rear fork 108 assembly, the front wheel 114 and the rear wheel with electric motor 116 can be detached and carried by unlocking the respective interlocking elements. Thus, folding of the electric vehicle requires less storage space and provides ease of transportation. A schematic representation of the detached structure of assemblies is illustrated in FIGS. 2A and 2B.

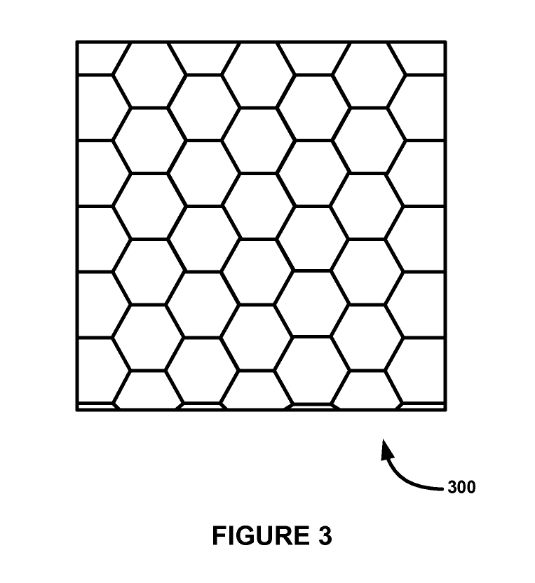

In one embodiment, the body of the electrically powered vehicle 100 including one or more components described above can be made using acrylonitrile butadiene styrene (ABS) thermoplastic material which contributes to the light weight of the vehicle 100. Additionally, materials such as graphite, carbon fiber, Teflon, nylon polyurethane, stainless steel, aluminum and the like can be used independently or in combination in several sections or in a single section of the electrically powered vehicle 100. In another embodiment, the body of the electrically powered vehicle 100 including one or more components described above can be of inflatable honeycomb beehive type structure. The honeycomb type structure has independent one way air valves. In case of puncture of a honeycomb, self sealing glue is provided to repair the puncture area. An exemplary honeycomb beehive structure 300 is illustrated in FIG. 3.

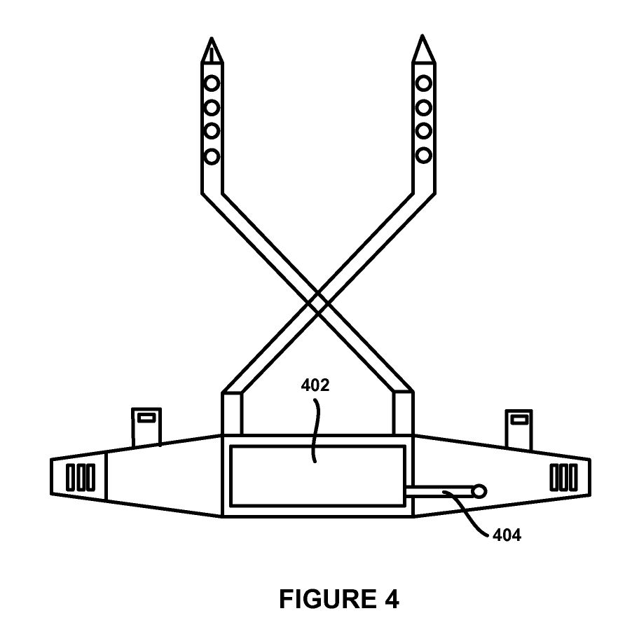

When the electrically powered vehicle is used for transportation, the electrical motor (e.g., a foot, flange, hub, or pan cake motor) for driving the rear wheel is provided by a portable power pack with a belt/nap sack 402 as shown in FIG. 4. In some embodiments, the portable power pack 402 can be used to re-charge a fixed battery (e.g., valve regulated lead acid (VRLA) battery, nickel-metal hydride battery (NIMH)) or drive the electrical motor directly. In these embodiments, the fixed battery 148 is housed in one of the members 118-122 of the foldable chassis frame 102.

The portable power pack 402 may include fuel cell battery, lithium ion battery, lithium polymer battery, nickel-cadmium battery, nickel-hydrogen battery, nickel-metal hydride battery, and lead acid battery. The portable power pack 402 is provided with a lock to attach and detach from the electrically powered vehicle 100.

The portable power pack 402 is designed such that it can be worn by a rider or pillion of the electrically powered vehicle 100 and can be charged at convenient charging point using a charger 404, thereby eliminating the need to carry the vehicle 100 to the charging point. Further, the portable power pack 402 can be carried indoors when the charging point are located inside a building. Alternatively, the fixed battery 148 or the portable power pack 402 can be recharged using the electric motor acting as a generator when the vehicle 100 is stationery.

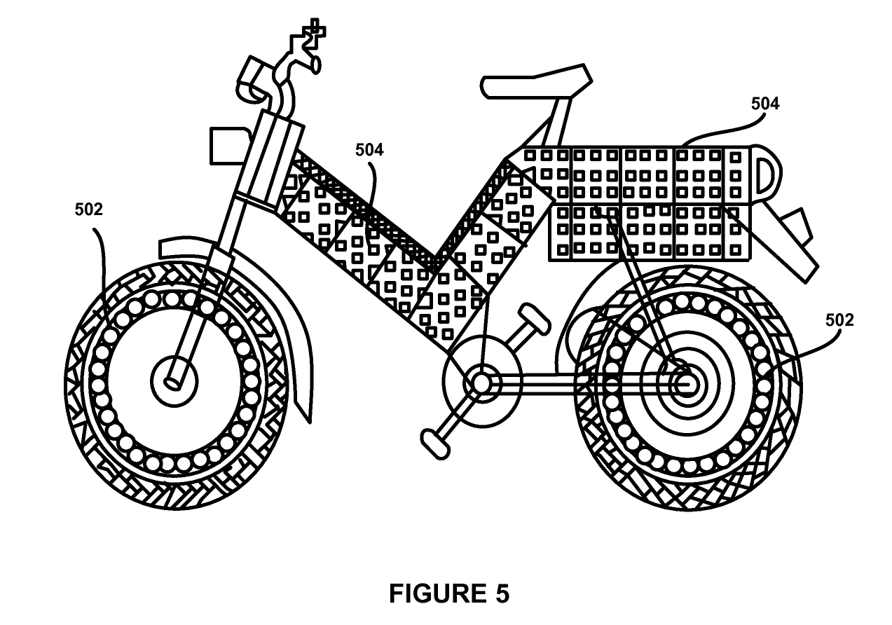

In an alternate embodiment, the foldable electrically powered vehicle 100 may be driven using the power from batteries embedded on both side of the rim of the front wheel 116 and the rear wheel 118. In accordance with one or more embodiments described above, the fixed batteries, the portable power pack or batteries in the rim are recharged using the solar cells embedded on the surface of the vehicle 100. It can be noted that, one or more solar panels constituting solar cells can be folded when not in use. Also, the belt of portable power pack 402 can have solar cell embedded on it to charge the power pack 402. An exemplary representation of batteries embedded in the rim 502 and solar cell layers 504 on the vehicle 100 is shown in FIG. 5.

In various embodiments described in FIGS. 1-5 provides a foldable electrically powered vehicle that facilitates fast folding mechanism, acquire less storage space and ease for transportation.

It will be recognized that the above described invention may be embodied in other specific forms without departing from the spirit or essential characteristics of the disclosure. Thus, it is understood that, the invention is not to be limited by the foregoing illustrative details, but it is rather to be defined by the appended claims.

What is claimed is:

1. A foldable electrically powered vehicle comprising:
a foldable chassis frame having members, wherein the members are connected using interlocking elements such that the foldable chassis frame is folded by unlocking each interlocking element connecting the members;
a front fork interlocked with the first member of the foldable chassis frame;
a swing arm interlocked with the second member of the foldable chassis frame; and
a rear fork interlocked with the third member of the foldable chassis frame, wherein the foldable chassis member, the front fork, the rear fork and the swing arm are detached by unlocking respective interlocking elements.

2. The vehicle of claim 1, further comprises an adjustable seat member interlocked with the third member of the foldable chassis frame.

3. The vehicle of claim 1, further comprises a front wheel interlocked with the front fork.

4. The vehicle of claim 1, further comprises a rear wheel with a hub motor interlocked with the swing arm and the rear fork.

5. The vehicle of claim 1, further comprises a handle connected to the front fork.

6. The vehicle of claim 3, wherein at least one of the front wheel and the rear wheel includes batteries embedded inside the rim in a circumferential manner for providing power to the foldable electric vehicle.

7. The vehicle of claim 4, wherein at least one of the front wheel and the rear wheel includes batteries embedded inside the rim in a circumferential manner for providing power to the foldable electric vehicle.

8. The vehicle of claim 7, wherein the batteries are selected from the group consisting of fuel cell batteries, lithium ion batteries, lithium polymer batteries, nickel-cadmium batteries, nickel-hydrogen batteries, nickel-metal hydride batteries, and lead acid batteries.

9. The vehicle of claim 8, further comprises one or more solar panels attached to the foldable chassis frame for charging the batteries.

10. The vehicle of claim 1, wherein the foldable chassis frame is made using an inflatable honeybee beehive type structure.

11. A foldable chassis frame for a vehicle comprising:
a first member;
a second member interlocked with the first member using a first interlocking element; and
a third member interlocked with the second member using a second interlocking element, wherein the chassis frame is folded to form member stack by unlocking the first and second interlocking elements.

12. The foldable chassis frame of claim 11, wherein the first member is interlocked with a front fork of a vehicle using a third interlocking element.

13. The foldable chassis frame of claim 11, wherein the second member is interlocked with a swing arm of a vehicle using a fourth interlocking element.

14. The foldable chassis frame of claim 11, wherein the third member is interlocked with a rear fork of a vehicle using a fifth interlocking element.

15. The foldable chassis frame of claim 14, wherein the third member is interlocked with a seat of a vehicle using a sixth interlocking element.

16. The foldable chassis frame of claim 11, wherein the first member, the second member and the third member are made using a honeycomb beehive type structure with independent air valves.

17. The foldable chassis frame of claim 11, wherein at least one of the first member, second member and third member houses fixed batteries for providing power to a vehicle.
